(19) United States
(12) Patent Application Publication
(10) Pub. No.: US 2024/0212010 A1
(43) Pub. Date: Jun. 27, 2024

(54) BILLING SYSTEM, BILLING METHOD, AND RECORDING MEDIUM

(71) Applicant: NEC Corporation, Tokyo (JP)

(72) Inventors: Kiri INAYOSHI, Tokyo (JP); Kentaro Nishida, Tokyo (JP)

(73) Assignee: NEC Corporation, Tokyo (JP)

(21) Appl. No.: 18/543,004

(22) Filed: Dec. 18, 2023

(30) Foreign Application Priority Data
Dec. 23, 2022 (JP) 2022-207345

(51) Int. Cl. G06Q 30/04; G06F 3/04815; G06Q 30/0242

(52) U.S. Cl. CPC G06Q 30/04; G06F 3/04815; G06Q 30/0242

(57) ABSTRACT

The billing system includes a detection unit, an estimation unit, a determination unit, and an output unit. The detection unit detects an action of an avatar on an object in a virtual space based on a detection result of the action of the avatar. The estimation unit estimates a degree of contribution of the object to the revenue generated by the action of the avatar in the virtual space. The determination unit determines an allocation of revenue generated in the virtual space to a related entity based on the estimated degree of contribution of the object. The output unit outputs the determined allocation.

This application is based upon and claims the benefit of priority from Japanese Patent Application No. 2022-207345, filed on Dec. 23, 2022, the disclosure of which is incorporated herein in its entirety by reference.

### TECHNICAL FIELD

The present disclosure relates to a billing system and the like.

### BACKGROUND ART

Usage fees in a virtual space may be charged according to an action of an avatar in the virtual space. For example, the information processing apparatus of PTL 1 (JP 2019-192172 A) registers the billing information corresponding to the action of the avatar in the virtual space in association with the avatar. Then, in a case where the avatar has exited from the virtual space, the information processing apparatus executes payment processing according to the registered billing information.

### SUMMARY

An object of the present disclosure is to provide a billing system or the like capable of appropriately allocating revenue related to an object according to an avatar action.

A billing system according to an aspect of the present disclosure includes a detection unit that detects an action of an avatar on an object in a virtual space, an estimation unit that estimates a degree of contribution of an object to revenue generated by an action of an avatar in a virtual space based on a detection result of the action of the avatar, a determination unit that determines an allocation of revenue generated in the virtual space to a related entity based on the estimated degree of contribution of the object, and an output unit that outputs the determined allocation.

A billing method according to an aspect of the present disclosure includes detecting an action of an avatar on an object in a virtual space, estimating a degree of contribution of an object to revenue generated by an action of an avatar in a virtual space based on a detection result of the action of the avatar, determining an allocation of revenue generated in the virtual space to a related entity based on the estimated degree of contribution of the object, and outputting the determined allocation.

A non-transitory recording medium according to an aspect of the present disclosure recording a billing program that causes a computer to execute a process of detecting an action of an avatar on an object in a virtual space, a process of estimating a degree of contribution of an object to revenue generated by an action of an avatar in a virtual space based on a detection result of the action of the avatar, a process of determining an allocation of revenue generated in the virtual space to a related entity based on the estimated degree of contribution of the object, and a process of outputting the determined allocation.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of a configuration of an example embodiment of the present disclosure.

FIG. 2 is a diagram schematically illustrating an example of a display screen according to the example embodiment of the present disclosure.

FIG. 3 is a diagram schematically illustrating an example of a display screen according to the example embodiment of the present disclosure.

FIG. 4 is a diagram illustrating an example of a configuration of the billing system according to the example embodiment of the present disclosure.

FIG. 5 is a diagram schematically illustrating an example of a display screen according to the example embodiment of the present disclosure.

FIG. 6 is a diagram schematically illustrating an example of a display screen according to the example embodiment of the present disclosure.

FIG. 7 is a diagram illustrating an example of an operation flow of the billing system according to the example embodiment of the present disclosure.

FIG. 8 is a diagram illustrating an example of a hardware configuration of the billing system of the present disclosure.

### EXAMPLE EMBODIMENT

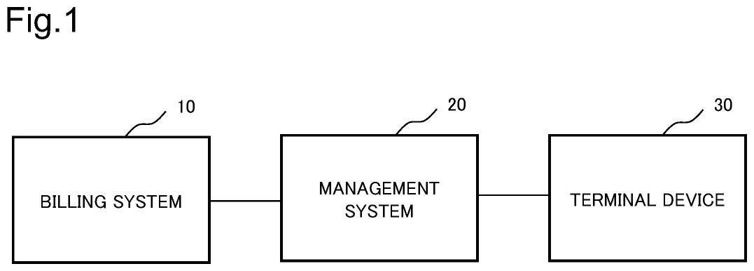

Example embodiments of the present disclosure will be described in detail with reference to the drawings. FIG. 1 is a diagram illustrating an outline of a configuration of a virtual space system of the present disclosure. The virtual space system includes, for example, a billing system 10, a management system 20, and a terminal device 30. The billing system 10 is connected to the management system 20 via a network. In addition, the management system 20 is connected to the terminal device 30 via a network.

The numbers of management systems 20 and terminal devices 30 can be appropriately set.

The virtual space system is, for example, a system in which a user who operates an avatar present in the virtual space performs an activity in the virtual space via the avatar. In the virtual space, the user interacts with another user via the avatar, for example. Here, the avatar refers to each avatar that the user using the virtual space operates to perform an activity in the virtual space. That is, even in the avatars of the same design, the respective avatars that perform activities in the virtual space by the operation of the user are regarded as different avatars from each other. Furthermore, the user may have a plurality of avatars. In a case where the user possesses a plurality of avatars, the user selects one of the plurality of avatars for each virtual space or according to a scene, and performs an activity in the virtual space by operating the selected avatar. In addition, the virtual space in which the user participates by operating the avatar present in the virtual space is also referred to as a metaverse space.

For example, the billing system 10 makes a determination related to the allocation of revenue generated due to the action of the avatar in the virtual space. The management system 20 manages, for example, display of a space in a virtual space, display of an object in the space, and movement of an avatar in the space. Furthermore, the terminal device 30 is, for example, a terminal device in which a user who uses a virtual space via an avatar operates the avatar.

The allocation of the revenue generated in the virtual space is, for example, the allocation of the usage fee related to the virtual space. In the virtual space, for example, management of the virtual space and arrangement of an object in the virtual space may be performed by another entity. The entity includes a person, an organization to which the person belongs, or an organization that entrusts business to the person. In a case where the management of the virtual space and the entity that arranges the object are different from each other, a part of the usage fee for the virtual space is allocated to the entity that arranges the object, for example, as a reward for arranging the object. Furthermore, in a case where the advertiser bears all or part of the usage fee for the virtual space, the allocation of the revenue generated in the virtual space may be the allocation of the burden amount of the usage fee. Furthermore, in a case where the object is displayed as an advertisement, the determination of the allocation of the revenue generated in the virtual space may be a determination related to an advertisement rate.

For example, the billing system 10 determines an allocation of revenue generated due to the action of the avatar to the object based on a degree of contribution of the object to the action of the avatar in the virtual space. The degree of contribution to the action of the avatar in the virtual space is, for example, an index indicating a degree of contribution to use of the virtual space by the avatar. Contribution to the avatar's utilization of the virtual space is, for example, promoting a longer time or an increased number of times the avatar stays in the virtual space. For example, the degree of contribution is set such that the more the avatar contributes to using the virtual space, the higher the degree of contribution becomes. For example, the degree of contribution is set such that the more the object contributes to the avatar's use of the virtual space, the higher the degree of contribution of the object becomes. Furthermore, the degree of contribution is set such that, for example, as the virtual space contributes to the avatar using the virtual space, the degree of contribution of the object becomes lower. For example, the degree of contribution is set such that the longer the time the avatar stays in the virtual space due to the presence of the object, the higher the value of the degree of contribution of the object becomes. Furthermore, for example, the degree of contribution is set such that the more the presence of the object increases the number of times the avatar visits the virtual space, the higher the value of the degree of contribution of the object becomes.

The degree of contribution of the object may be set by a plurality of stages. In a case where the degree of contribution of the object is set in a plurality of stages, the degree of contribution is set to be higher as the presence of the object increases the time the avatar stays in the virtual space, for example. In addition, contribution to the avatar's utilization of the virtual space may be to encourage a user of the avatar to purchase an item or service. In this case, for example, the degree of contribution is set such that the more the presence of the object increases the purchase amount or the number of purchases of the product or service by the user of the avatar, the higher the value of the degree of contribution of the object becomes.

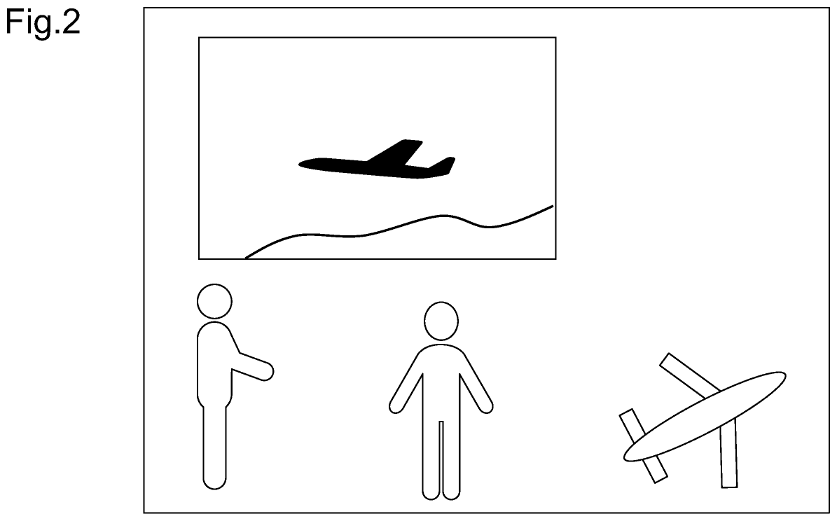

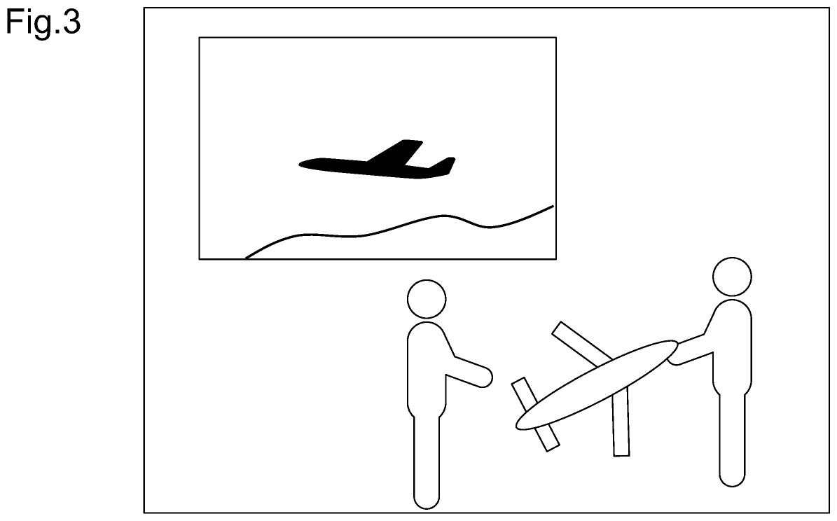

FIGS. 2 and 3 are diagrams schematically illustrating an example of a display screen of a virtual space. In the example of the display screen of FIGS. 2 and 3, a video of an aircraft flying in the sky is displayed in the upper left frame. In addition, in the example of the display screen of FIGS. 2 and 3, an aircraft object is arranged at the lower right. Furthermore, in the example of the display screen of FIGS. 2 and 3, two avatars exist in the virtual space. In the example of the display screen of FIGS. 2 and 3, the display of the video of an aircraft is set by, for example, the entity operating the virtual space. In addition, in the example of the display screen of FIGS. 2 and 3, the objects of the aircraft are arranged by an entity other than the entity that operates the virtual space.

The example of the display screen of FIG. 2 illustrates a state in which the avatar is viewing a video displayed in the virtual space. In the example of the display screen of FIG. 2, the two avatars are oriented toward the video. In the example of the display screen of FIG. 2, in a case where the displayed video is a video of content related to the theme of the virtual space, the user of each of the two avatars is in a state of being interested in the virtual space. Thus, the virtual space has a higher degree of contribution to the avatar staying in the virtual space than the object. Therefore, in the example of the display screen of FIG. 2, the allocation of revenue to the virtual space increases.

On the other hand, the example of the display screen of FIG. 3 illustrates a state in which the two avatars are interested in the object. In the example of the display screen of FIG. 3, the right avatar handles the object. Furthermore, in the example of the display screen of FIG. 3, the left avatar is oriented toward the object. In the example of the display screen of FIG. 3, the user of each of the two avatars is in a state of being interested in the object. Thus, the object has a higher degree of contribution to the avatar staying in the virtual space than the virtual space. Therefore, in the example of the display screen of FIG. 3, the allocation of the revenue to the object is increased.

The billing system 10 acquires, for example, data related to the avatar in the virtual space from the management system 20. The data related to the avatar is, for example, the identifier of the avatar existing in the virtual space, the position of the avatar, the data of the movement of the avatar, and information related to the user operating the avatar. For example, the billing system 10 detects an action of the avatar on the object from the data related to the avatar in the virtual space. When detecting the action of the avatar, the billing system 10 estimates the degree of contribution of the object to the revenue generated by the action of the avatar in the virtual space based on, for example, the action of the avatar on the object. Then, the billing system 10 determines the allocation of the revenue generated in the virtual space to the related entity based on the estimated degree of contribution of the object. The related entity is, for example, an entity related to revenue generated by the action of the avatar in the virtual space. An entity related to the revenue generated by the action of the avatar in the virtual space is, for example, an entity that receives the allocation of revenue. Furthermore, the entity related to the revenue generated by the action of the avatar in the virtual space may be, for example, an entity that pays money that is a source of the revenue.

The related entity is, for example, an entity that manages the virtual space and an entity that arranges the object. The entity that operates the virtual space includes, for example, an entity that creates the virtual space and an entity that manages the virtual space. The related entity may be either an entity that manages the virtual space or an entity that arranges the object. Examples of the entity that arranges the object include an entity that has created the object and an entity that has arranged the object in the virtual space. Furthermore, in a case where the object is arranged as an advertisement, the related entity may include an advertiser. The advertiser and the entity arranging the object may be the same. The object used as the advertisement is, for example, an object in which a company name, a product name, a service name, or an event name is described in the object. The object used as the advertisement may be an object of a character in a company, a product, a service, or an event. Furthermore, the object used as the advertisement may be an object in the form of a product to be an advertisement target. The object used as the advertisement is not limited to the above. The entity involved is not limited to the above.

The billing system 10 outputs the determined allocation of revenue to the management system 20, for example. For example, the management system 20 calculates the revenue generated by the action of the avatar based on the allocation of the revenue acquired from the billing system 10. The management system 20 outputs the calculated revenue to, for example, a terminal device used by an entity that operates the virtual space and a terminal device used by an entity that arranges the object. The management system 20 may output the calculated revenue to the terminal device 30 used by the user of the virtual space. Furthermore, the calculation of the revenue generated by the action of the avatar may be performed in the billing system 10. In addition, the billing system 10 may output the allocation of revenue to the payment system. In addition, the billing system 10 may output the calculated revenue. The output revenue may be a point used in the payment system or an amount of virtual currency.

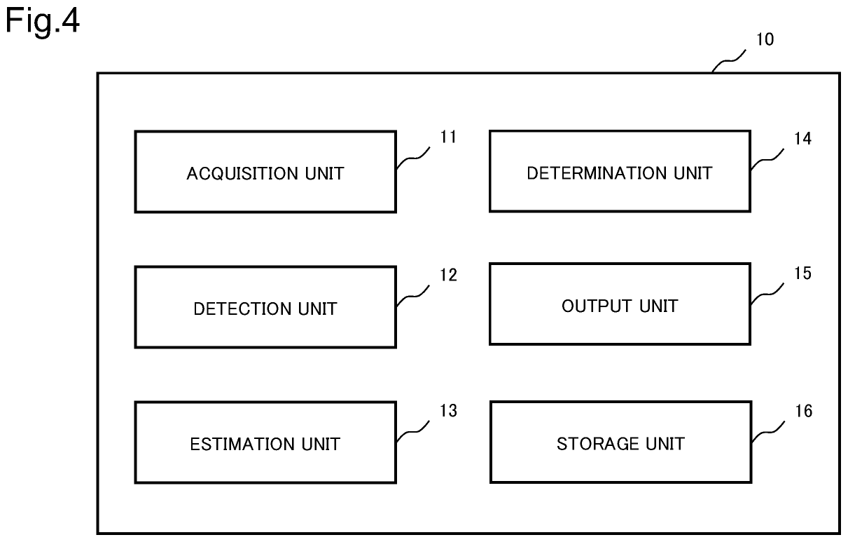

Here, an example of a specific configuration of the billing system 10 will be described. FIG. 4 is a diagram illustrating an example of a configuration of the billing system 10. The billing system 10 includes a detection unit 12, an estimation unit 13, a determination unit 14, and an output unit 15 as a basic configuration. The billing system 10 further includes, for example, an acquisition unit 11 and a storage unit 16.

The acquisition unit 11 acquires, for example, data related to the avatar in the virtual space. The data related to the avatar is, for example, the identifier of the avatar existing in the virtual space, the position of the avatar, the data of the movement of the avatar, and information related to the user operating the avatar. The information related to the user operating the avatar is information of one or more items among the identifier of the user, the attribute of the user, the name used by the user in the virtual space, the attribute of the user, and the use history of the virtual space of the user. The information related to the user operating the avatar is not limited to the above, and the data related to the avatar is not limited to the above. The acquisition unit 11 may further acquire data related to the object. The data related to the object is, for example, an identifier of the object, a position of the object, and data of an action of the object. The data related to the object may include information indicating an entity that arranges the object or a type of the object. The information indicating the type of the object is, for example, information indicating whether the object is an advertisement. The data related to the object is not limited to the above. The acquisition unit 11 acquires, for example, data related to the avatar in the virtual space and data related to the object from the management system 20.

The detection unit 12 detects the action of the avatar on the object in the virtual space. For example, the detection unit 12 detects the action of the avatar on the object based on the data related to the avatar in the virtual space acquired by the acquisition unit 11. By detecting the action of the avatar on the object, the detection unit 12 detects, for example, whether the avatar is interested in the object. Furthermore, in a case where a plurality of objects is arranged in the virtual space, the detection unit 12 may detect the action of the avatar with respect to each object.

The action of the avatar on the object is, for example, an action in which the avatar handles the object or an action in which the avatar faces the object. The action of the avatar on the object may be both an action in which the avatar handles the object and an action in which the avatar turns toward the object. The action in which the avatar handles the object is an action in which the avatar touches the object, an action in which the avatar lifts the object, an action in which the avatar places the object, or an action in which the avatar changes the shape of the object. In the example of the display screen of FIG. 3, the action in which the avatar handles the object is an action in which the right avatar of the two avatars holds an aircraft object. The action in which the avatar handles the object is not limited to the above.

Furthermore, the action of handling the object may include, for example, a response of the user operating the avatar to processing generated by the action of the avatar. The action of handling the object includes, for example, the user's response to a button displayed when the avatar approaches the object. For example, in a case where it is set that a button is displayed when the avatar approaches the object, the action of handling the object includes that the user operating the avatar clicks the button by mouse operation or presses the button by a controller worn on the body.

For example, it is assumed that the object is a box of lots installed in a virtual space that reproduces a shrine. Furthermore, it is assumed that processing of displaying a button of “use” is performed when the avatar approaches the box of the lot by a predetermined distance. In addition, it is assumed that processing is performed in which, when the user presses a button by an operation with a mouse or by a controller worn on the hand, a result (paper surface) of a written lot is displayed. In this case, when the button is displayed, the user's operation with the mouse or the operation of pressing the button by the controller worn on the hand is included in the action of handling the object.

The action in which the avatar faces the object is, for example, that the line of sight of the avatar or the face faces the object. In the example of the display screen of FIG. 3, the action in which the avatar faces the object is an action in which the left avatar of the two avatars faces the object of the aircraft. In the example of the display screen of FIG. 3, each of the two avatars is in a state of being interested in the object. Furthermore, the action in which the avatar faces the direction of the object is not limited to the above.

The action of the avatar on the object may be that the avatar makes a conversation about the object. When the object is positioned as an entrance to another virtual space, the action of the avatar on the object may be moving to the other virtual space via the object. The action of the avatar on the object is not limited to the above.

The detection unit 12 detects, for example, the degree of action of the avatar on the object. The detection unit 12 detects, for example, the time during which the avatar is acting on the object or the number of times the avatar has acted. The detection unit 12 may detect the distance between the avatar and the object. In the case of detecting the distance, the detection unit 12 may detect a target object on which the avatar is performing an action based on the detected distance. Furthermore, the detection unit 12 may detect the number of times a response is made to processing that occurs when the avatar approaches the object. For example, the detection unit 12 may detect the number of times the button displayed when the avatar approaches the object is pressed.

The detection unit 12 detects, for example, the time or the number of times the avatar is handling the object. For example, the detection unit 12 detects the time during which the avatar is facing the direction of the object or the number of times the avatar is facing the direction of the object. Furthermore, the detection unit 12 detects, for example, the time or the number of times the avatar is having a conversation related to the object. For example, the detection unit 12 detects the time or the number of times the avatar is having a conversation related to the object by using a conversation analysis model. The conversation analysis model is generated using well-known natural language processing methods. In addition, the analysis model is generated, for example, in a system outside the billing system 10. Furthermore, in a case where the object is arranged as an entrance to another virtual space, the detection unit 12 detects, for example, the movement of the avatar to another virtual space.

The detection unit 12 may detect an operation related to an object by a user who operates the object. The detection unit 12 detects, for example, clicking on a uniform resource locator (URL) displayed in association with the object. The detection unit 12 may detect at least one of browsing of a web site related to the object and purchase of an item by the user who operates the object.

The estimation unit 13 estimates the degree of contribution of the object to the revenue generated by the action of the avatar in the virtual space based on the detection result of the action of the avatar. The estimation unit 13 estimates the degree of contribution of the object based on, for example, at least one of the number of times the avatar acts on the object and the time during which the avatar is acting on the object. The number of times of actions on the object may include, for example, the number of times of actions taken for processing that occurs when the avatar approaches the object. For example, the number of times of actions on the object may include the number of times a button displayed when the avatar approaches the object is pressed. For example, the estimation unit 13 estimates the degree of contribution of the object to the revenue generated by the action of the avatar, using the criterion for estimating the degree of contribution. For example, the estimation unit 13 estimates the degree of contribution of the object based on at least one of the number of times of the action of the avatar on the object and time. Furthermore, in a case where a plurality of objects is arranged in the virtual space, the estimation unit 13 may estimate the degree of contribution of each object.

The criterion for estimating the degree of contribution is set such that the value indicating the degree of contribution increases as the number of times of the avatar handling the object increases, for example. Furthermore, the criterion for estimating the degree of contribution may be set such that the value indicating the degree of contribution increases as the time for the avatar to handle the object increases. For example, in a case where the virtual space is a virtual space on the theme of sports and a ball of the original design is arranged as an object, the criterion for estimating the degree of contribution is set such that the value indicating the degree of contribution becomes higher as the time the avatar plays with the ball becomes longer. The criterion for estimating the degree of contribution may be set such that the value indicating the degree of contribution increases as the number of times of facing the direction of the object of the avatar increases. Furthermore, the criterion for estimating the degree of contribution may be set such that the value indicating the degree of contribution increases as the time during which the avatar is facing the direction of the object becomes longer. For example, in a case where the virtual space is a virtual space with a theme of a shrine and is arranged as an object from which a written lot can be drawn, the criterion for estimating the degree of contribution is set such that the value indicating the degree of contribution increases as the number of times of drawing the written lot increases.

The estimation unit 13 may estimate the degree of contribution of the object based on the ratio of the conversation related to the object in the conversation between the avatars. Furthermore, in a case where a plurality of objects exists in the virtual space, the estimation unit 13 may estimate the degree of contribution of the object based on a conversation ratio for each object. For example, the estimation unit 13 calculates a ratio between a conversation related to the virtual space and a conversation related to the object among the conversations performed by the avatar. Then, the estimation unit 13 estimates the degree of contribution of the object based on the calculated ratio. For example, the criterion for estimating the degree of contribution is set such that the value indicating the degree of contribution increases as the ratio of the conversation related to the object increases. For example, in a case where the virtual space is a virtual space with a tourist spot as a theme and an aircraft is arranged as an object, the criterion for estimating the degree of contribution is set such that the value indicating the degree of contribution increases as the ratio of conversations related to transportation means for going to the tourist spot increases.

The estimation unit 13 may estimate the degree of contribution of the object based on at least one of the attribute of the avatar and the attribute of the user who operates the avatar. For example, the estimation unit 13 estimates the degree of contribution of the object based on the attribute of the user who operates the avatar. The criterion for estimating the degree of contribution is set such that, for example, when the avatar operated by the user having a large influence on other users performs an action on the object, a value indicating the degree of contribution becomes higher than that in the case of the avatar operated by other users. The user having a large influence on other users is, for example, a user operating an avatar whose action on an object is likely to lead to an action of an avatar operated by another user on the same object. For example, when an avatar operated by an influencer with a large number of followers on a social networking service (SNS) performs an action on an object, a value indicating the degree of contribution is set to be higher than that of an avatar operated by another user.

The attribute of the user is, for example, information related to the degree of influence on other users. The attribute of the user is, for example, one or more of the number of times of use, occupation, status in the organization, the number of followers in the moving image site, the number of followers on the SNS, and the number of friend registrants in the virtual space. The number of friend registrants is, for example, a list for registering other users who interact or contact. The attribute of the user is not limited to the above.

For example, the estimation unit 13 estimates the degree of contribution of the object based on the attribute of the avatar performing an action on the object. The criterion for estimating the degree of contribution is set such that, for example, when the avatar having a large influence on other users performs an action on the object, a value indicating the degree of contribution becomes higher than that of the other avatars. The avatar having a large influence on other users is, for example, an avatar whose action on an object is likely to lead to an action of an avatar operated by another user on the same object. For example, the criterion for estimating the degree of contribution is set such that when an avatar using a popular animation character performs an action on an object, a value indicating the degree of contribution becomes higher than that in the case of an avatar operated by another user.

The avatar attribute is, for example, one or more of an avatar design, an avatar creator, an avatar provider, the number of days since the avatar starts to be used, information about whether the avatar is the original, whether the avatar is official or unofficial, the number of people using the same avatar, and whether the avatar is paid or free. The attribute of the avatar is not limited to the above.

The determination unit 14 determines the allocation of revenue generated in the virtual space to a related entity based on the estimated degree of contribution of the object. For example, the determination unit 14 determines an allocation to the entity that arranges the object based on the degree of contribution of the object. Furthermore, in a case where a plurality of objects is arranged in the virtual space, the determination unit 14 may determine the allocation for each object to an entity that arranges the object.

The criterion for determining the allocation to the entity that arranges the object based on the degree of contribution of the object is set by, for example, the entity operating the virtual space. The criterion for determining the allocation to the entity that arranges the object based on the degree of contribution of the object is set using, for example, a data table defining a relationship between the degree of contribution of the object and the allocation to the entity that arranges the object. For example, the determination unit 14 extracts a value of the allocation corresponding to the degree of contribution of the object from the data table, thereby determining the allocation of the revenue generated in the virtual space to the related entity. The determination unit 14 may determine the allocation of revenue generated in the virtual space to a related entity using a calculation formula. The calculation formula is, for example, a function having the degree of contribution of the object as an explanatory variable and the allocation as an objective variable. The explanatory variables may include explanatory variables corresponding to items other than the degree of contribution of the object.

For example, the determination unit 14 determines the allocation of the usage fee for the virtual space to the entity that arranges the object based on the degree of contribution of the object to the fact that the avatar stays in the virtual space. For example, the determination unit 14 determines the allocation of the usage fee for the virtual space to the entity that arranges the object based on the degree of contribution of the object to at least one of the length of time and the number of times the avatar stays in the virtual space. For example, the determination unit 14 determines the allocation of the usage fee for the virtual space by the avatar user to the object based on the degree of contribution of the object. In the usage fee for the virtual space by the avatar user, the criterion for determining the allocation to the object is set such that, for example, the higher the degree of contribution of the object, the larger the allocation to the entity that arranges the object.

In a case where the object is an object displayed as an advertisement, the determination unit 14 determines the allocation of the cost related to the advertisement to the advertiser based on, for example, the degree of contribution of the object to the fact that the avatar stays in the virtual space. Here, the cost related to the advertisement allocated to the advertiser is, for example, a fee paid by the advertiser to the entity operating the virtual space. The determination unit 14 determines the allocation of the cost related to the advertisement to the advertiser based on the degree of contribution of the object to at least one of the length of time and the number of times the avatar stays in the virtual space. The cost related to the advertisement is, for example, a cost generated by displaying the advertisement. The cost related to the advertisement is, for example, a cost required for displaying the advertisement, a fee, and a display cost of the advertisement. The cost related to the advertisement is not limited to the above. For example, the determination unit 14 determines the allocation of the cost related to the advertisement to the advertiser based on the degree of contribution of the object to at least one of the time and the number of times the avatar stays in the virtual space. The allocation related to the advertisement revenue to the advertiser is used, for example, as an index for calculating the advertisement revenue according to the effect of the advertisement.

In a case where the object is an object displayed as an advertisement and at least a part of the usage fee at the time when the avatar user uses the virtual space is paid by the advertiser arranging the object, the determination unit 14 determines the allocation to be paid by the advertiser among the usage fee based on, for example, the degree of contribution of the object to the fact that the avatar stays in the virtual space. For example, in a case where the usage fee for the virtual space, of the user who operates the avatar is free when an action is performed on the object displayed as the advertisement, the determination unit 14 determines the usage fee to be paid by the advertiser on behalf of the user to the operator of the virtual space. For example, the determination unit 14 determines the allocation to be paid by the advertiser among the usage fee based on the degree of contribution of the object to at least one of the length of time and the number of times the avatar stays in the virtual space.

In a case where whether the handling action is paid or free is set for each object, the determination unit 14 may determine the allocation of the revenue to the object based on the degree of contribution of the object. For example, in a case where the usage fee for a paid object is fixed, the determination unit 14 may determine the allocation of the revenue to each object based on the degree of contribution of each object. Furthermore, in a case where whether the handling action is paid or free is set for each action on the object, the determination unit 14 may determine the allocation of the revenue to the object based on the degree of contribution of the object when the action set as paid is performed.

In a case where the object is an object for movement to another virtual space, for example, when the avatar moves to another virtual space via the object, the determination unit 14 determines the allocation of generated revenue to a related entity. The revenue generated when the avatar moves to another virtual space via the object is, for example, the revenue paid by an entity that operates the virtual space as the movement destination. The entity that pays the revenue generated when the avatar moves to another virtual space via the object may be the entity that arranges the object. For example, the determination unit 14 determines the allocation of the generated revenue to the entity that arranges the object based on the number of times the avatar has moved to another virtual space via the object.

The determination unit 14 may determine the allocation so as to divide and increase the allocation to an object in which the number of avatars that have performed an action on the object is larger than that of other objects. For example, in a case where there are objects handled by a reference number or more of avatars, the determination unit 14 may set a value indicating the allocation to the entity in which the objects are arranged as a value obtained by multiplying the value by a normal value.

The determination unit 14 may determine the revenue related to the object based on the degree of contribution of the object. For example, the determination unit 14 determines the object usage fee by the avatar user based on the allocation to the object determined using the degree of contribution of the object. The determination unit 14 may determine, based on the degree of contribution of the object, the revenue related to an action on the object among the usage fee for the virtual space by the avatar user. For example, the determination unit 14 determines the revenue generated by the action on the object among the usage fee for the virtual space by the avatar user based on the degree of contribution of the object and the time or the number of times of performing the action on the avatar. Furthermore, in a case where the object is an object displayed as an advertisement, the determination unit 14 may determine the revenue to be charged to the advertiser based on the degree of contribution of the object to the time the avatar stays in the virtual space. In a case where the object is an object displayed as an advertisement and the advertiser exhibiting the object pays at least a part of the usage fee when the avatar user uses the virtual space, the determination unit 14 may determine the usage fee borne by the advertiser based on the degree of contribution of the object, for example.

The output unit 15 outputs the allocation determined by the determination unit 14. The output unit 15 outputs, for example, the allocation of the revenue generated by the action of the avatar to the object to the management system 20. The output unit 15 may output, to the payment system, the allocation of the revenue generated by the action of the avatar to the object. The output unit 15 outputs, for example, the allocation to the object and the identifier of the object in association with each other. Furthermore, in a case where a plurality of objects is arranged in the virtual space, the determination unit 14 may output the determined allocation for each object.

In a case where the determination unit 14 further determines the revenue generated by the action on the object of the avatar, the output unit 15 outputs, for example, the revenue generated by the action on the object to the management system 20. Furthermore, the output unit 15 may output the revenue generated by an action on an object to the terminal device 30 used by the user operating the avatar. In a case where the object is an object displayed as an advertisement, and the revenue to be charged to the advertiser is determined based on the degree of contribution of the object, the output unit 15 outputs, for example, the revenue to be paid by the advertiser among the revenue generated by the action of the avatar to the management system 20. Furthermore, in a case where the object is an object displayed as an advertisement, and the usage fee paid by the advertiser exhibiting the object is determined for at least a part of the usage fee when the avatar user uses the virtual space, the output unit 15 may output the revenue borne by the advertiser to the management system 20. Furthermore, the output unit 15 may output the revenue paid by the advertiser to the terminal device used by the advertiser.

The output unit 15 may output information indicating whether the object is paid or free. For example, the information indicating whether the use of the object is paid or free is referred to for determining whether the user performs an action on the object. Furthermore, the information on whether the use of the object is paid or free may be used for calculating the usage fee for the virtual space. The output unit 15 outputs, for example, information indicating whether the use of the object is paid or free to the management system 20. For example, the output unit 15 may output, to the terminal device 30, information indicating whether the use of the object is paid or free. Furthermore, the output unit 15 may output a total value of revenue generated up to the output time point. The output unit 15 may output a total value of revenue generated up to the output time point for the revenue related to the object. The output unit 15 outputs, for example, the total value of the revenue generated up to the output time point to the management system 20. For example, the output unit 15 outputs, to the terminal device 30, a total value of revenue generated up to the output time point for the revenue related to the object generated by the action of the avatar operated via the terminal device 30.

The storage unit 16 stores data related to determination of the allocation of revenue due to the action of the avatar on the object. The storage unit 16 stores a criterion for allocation of revenue generated by the action of the avatar on the object. The storage unit 16 stores, for example, a data table defining a relationship between a degree of contribution of an object and allocation to a related entity. In a case where the conversation of the avatar is analyzed using the estimation model, the storage unit 16 stores, for example, the estimation model. The estimation model may be stored in a storage means outside the billing system 10.

The management system 20 controls the display of the virtual space and the display of the avatar operating on the virtual space. The management system 20 outputs, for example, the display of the virtual space and the display data of the avatar operating on the virtual space to the terminal device 30. For example, the management system 20 controls the action of the avatar in the virtual space such that the avatar acts in accordance with the operation of the user. The management system 20 controls, for example, a conversation between avatars. For example, the management system 20 acquires an input related to the operation of the avatar by the user from the terminal device 30. The management system 20 controls the action of the avatar based on, for example, an input related to the operation of the avatar by the user. In addition, for example, the management system 20 calculates the revenue generated by each of the related entities based on the allocation of the revenue generated in the virtual space to the related entities acquired from the billing system 10. Then, the management system 20 outputs the calculated revenue to the terminal device used by each of the related entities.

The terminal device 30 is, for example, a terminal device in which the user of the virtual space operates the avatar and browses the virtual space. The terminal device 30 acquires, for example, an input related to the operation of the avatar input by the operation of the user. The terminal device 30 outputs, for example, an input related to the operation of the avatar to the management system 20. Furthermore, the terminal device 30 acquires the virtual space and the display data of the avatar from the management system 20, for example. The terminal device 30 outputs a display screen related to the virtual space to a display device (not illustrated), for example.

The terminal device 30 acquires the revenue related to the virtual space from the management system 20, for example. For example, the terminal device 30 acquires, from the management system 20, the revenue generated by the action of the avatar on the object in the usage fee for the virtual space. The terminal device 30 outputs the revenue related to the virtual space to the display device, for example.

In a case where the information on whether the use of the object is paid or free is acquired, the terminal device 30 outputs the information on whether the use of the object is paid or free to the display device, for example. In a case where the total value of the revenue related to the object generated by the action of the avatar is acquired, the terminal device 30 outputs the total value of the revenue related to the object to the display device, for example.

As the terminal device 30, for example, a smartphone, a personal computer, a tablet computer, or a wearable terminal can be used. Furthermore, the terminal device 30 may include a head-mounted display. The terminal device 30 is not limited to the above.

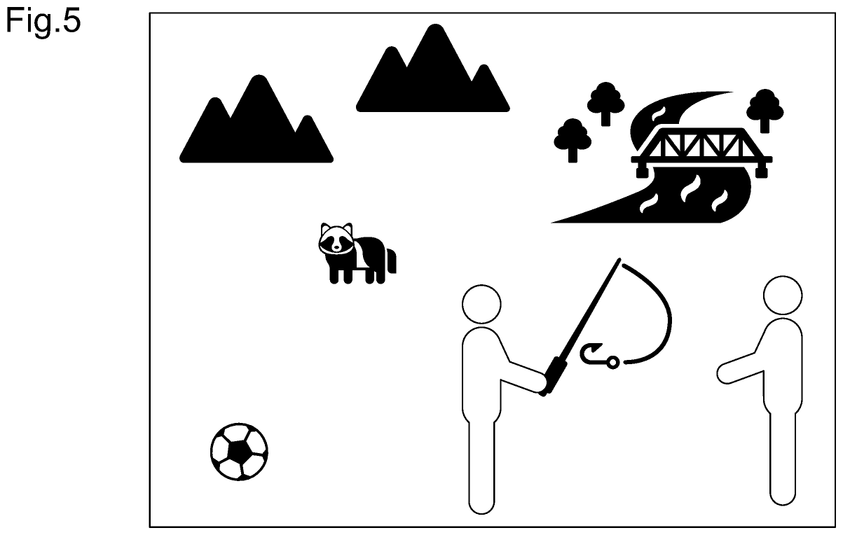

FIG. 5 is a diagram schematically illustrating an example of a display screen of a virtual space. The example of the display screen of FIG. 5 illustrates a virtual space with a natural park as a theme, which is a sightseeing spot. In the example of the display screen of FIG. 5, a ball object is arranged at the lower left, and a fishing tool object is arranged at the lower right. Furthermore, in the example of the display screen of FIG. 5, two avatars exist in the virtual space. In the example of the display screen of FIG. 5, the ball and fishing tool objects are arranged by an entity other than the entity that operates the virtual space.

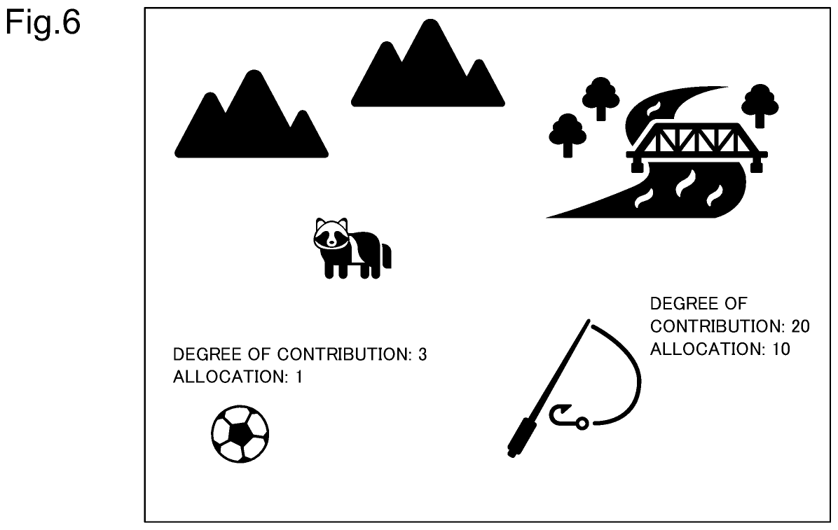

FIG. 6 is a diagram illustrating an example of a display screen that displays a degree of contribution of an object and the allocation of generated revenue in the example of the virtual space of FIG. 5. In the example of the display screen of FIG. 6, “degree of contribution” and “allocation” are displayed for each of the ball object on the lower left and the fishing tool object on the lower right. In the example of the display screen of FIG. 6, the “degree of contribution” indicates the degree of contribution of the object to the revenue generated by the action of the avatar in the virtual space. Furthermore, in the example of the display screen of FIG. 6, the “allocation” indicates the allocation of revenue generated in the virtual space to a related entity, which is determined based on the degree of contribution. In the example of the virtual space of FIG. 5, the user operating the avatar is in a state of being more interested in the fishing tool object than the ball object. Therefore, in the example of the display screen of FIG. 6, the “degree of contribution” and the “allocation” are higher in the fishing tool object than in the ball object.

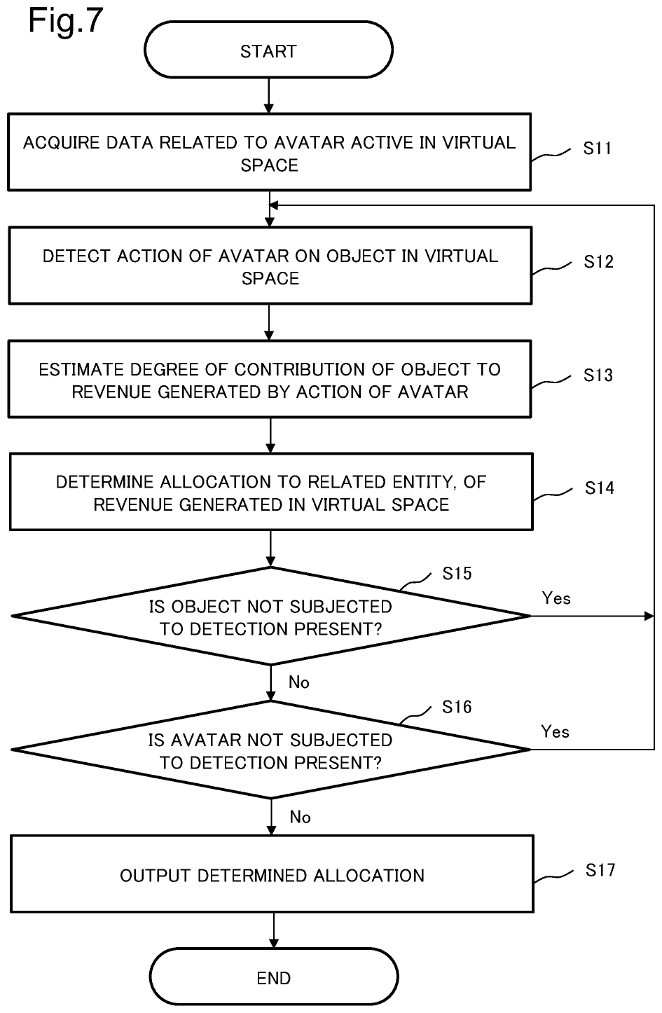

An operation of the billing system 10 will be described. FIG. 7 is a diagram illustrating an example of an operation flow of the billing system 10.

The acquisition unit 11 acquires, for example, data related to the avatar active in the virtual space (step S11). The acquisition unit 11 acquires, for example, data related to the avatar active in the virtual space from the management system 20 that manages the virtual space.

When the data related to the avatar is acquired, the detection unit 12 detects the action of the avatar on the object in the virtual space from the data related to the avatar (step S12).

When the action of the avatar on the object is detected, the estimation unit 13 estimates the degree of contribution of the object to the revenue generated by the action of the avatar in the virtual space based on the detection result of the action of the avatar (step S13).

When the degree of contribution of the object is estimated, the determination unit 14 determines the allocation of revenue generated in the virtual space to a related entity based on the estimated degree of contribution of the object (step S14).

When the allocation is determined, in a case where there is no other object in which the action of the avatar is not detected among the objects on which the avatar is performing the action (No in step S15), and there is no other avatar in which the action is not detected (No in step S16), the output unit 15 outputs the determined allocation (step S17).

In step S15, in a case where there is another object that has not detected the action of the avatar among the objects on which the avatar is performing the action (Yes in step S15), the processing returns to step S12, and the processing is repeated from the processing of detecting the action of the avatar on the object that has not been detected by the detection unit 12.

Furthermore, in step S16, in a case where there is another avatar that has not been detected (Yes in step S16), the processing returns to step S12, and is repeated from the processing of detecting the action on the object of the avatar that has not been detected by the detection unit 12.

In the virtual space, the billing system 10 estimates the degree of contribution of an object to revenue generated by an action of an avatar. Then, the billing system 10 determines the allocation of the revenue generated in the virtual space to the related entity based on the estimated degree of contribution of the object. Therefore, for example, in a case where the arrangement of the object greatly contributes to the use of the virtual space, it is possible to increase the allocation of revenue to the entity that arranges the object.

For example, when the allocation of the revenue to the object is set to a fixed value, in a case where the object is more attractive than the virtual space, the allocation of the revenue to the object may be a value that does not match the degree of contribution to the use of the virtual space. On the other hand, in the billing system 10 of the present example embodiment, the fairness of the allocation of revenue can be improved by determining the allocation to the action on the object according to the action on the object of the avatar. For example, in a case where the generated revenue is a usage fee for the virtual space, the billing system 10 can determine an allocation of the usage fee to the action on the object according to the action on the object of the avatar. The determined allocation to the object is used, for example, for calculation of revenue to be paid to the entity that arranges the object. By determining the allocation of the revenue obtained from the usage fee to the action on the object according to the action on the object of the avatar, the revenue can be appropriately allocated to the entity that arranges the object.

Furthermore, for example, in a case where the generated revenue is an advertisement rate of an object arranged as an advertisement, the billing system 10 can determine the allocation of the rate to be paid by the advertiser according to the action of the avatar by using the degree of contribution of the object in the action of the avatar as an effect of the advertisement. By determining the allocation of the fee paid by the advertiser according to the action of the avatar on the object, for example, the advertisement cost can be appropriately charged to the entity that arranges the object as the advertisement. In this manner, by detecting the action of the avatar on the object and determining the allocation of the revenue generated by the action of the avatar, the allocation of the revenue related to the object generated by the action of the avatar can be appropriately set according to the action of the avatar. Therefore, by using the billing system 10, it is possible to appropriately allocate the revenue related to the object according to the action of the avatar.

Each processing in the billing system 10 may be distributed and executed in a plurality of information processing apparatuses connected via a network. For example, the processing in the detection unit 12 and the estimation unit 13 and the processing in the determination unit 14 may be performed in separate information processing apparatuses. Furthermore, the processing in the detection unit 12 and the processing in the estimation unit 13 and the determination unit 14 may be performed in separate information processing apparatuses. Which of the plurality of information processing apparatuses performs each processing in the billing system 10 can be appropriately set.

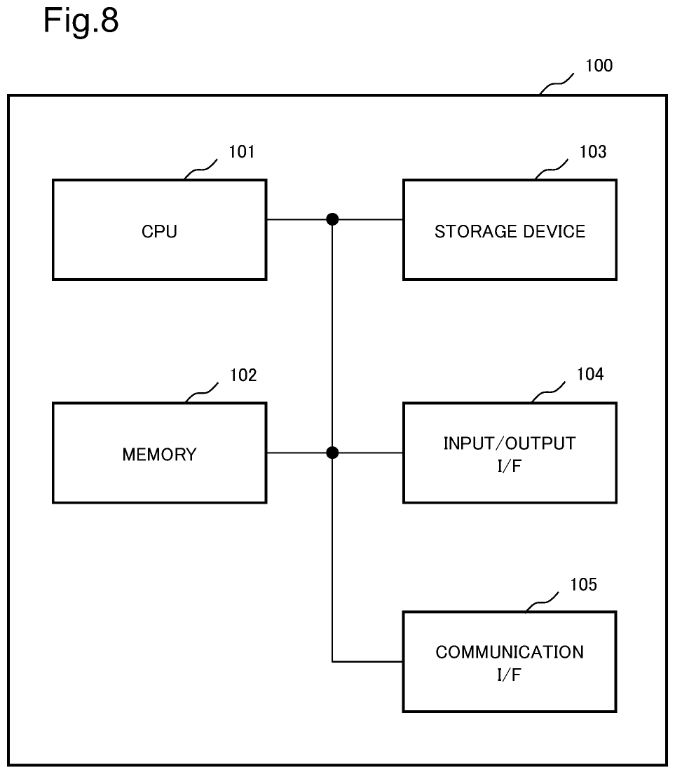

Each processing in the billing system 10 can be achieved by executing a computer program by a computer. FIG. 8 illustrates an example of a configuration of a computer 100 that executes a computer program for performing each processing in the billing system 10. The computer 100 includes, for example, a central processing unit (CPU) 101, a memory 102, a storage device 103, an input/output interface (I/F) 104, and a communication I/F 105.

The CPU 101 reads and executes a computer program for performing each processing from the storage device 103. The CPU 101 may be configured by a combination of a plurality of CPUs. In addition, the CPU 101 may be configured by a combination of a CPU and another type of processor. For example, the CPU 101 may be configured by a combination of a CPU and a graphics processing unit (GPU). The memory 102 includes a dynamic random access memory (DRAM) or the like, and temporarily stores a computer program executed by the CPU 101 and data being processed. The storage device 103 stores a computer program executed by the CPU 101. The storage device 103 includes, for example, a nonvolatile semiconductor storage device. As the storage device 103, another storage device such as a hard disk drive may be used. The input/output I/F 104 is an interface that receives an input from an operator and outputs display data and the like. The communication I/F 105 is an interface that transmits and receives data to and from another information processing apparatus. In addition, the management system 20 and the terminal device 30 may also have configurations similar to those of the computer 100.

The computer program used for executing each processing can also be allocated by being stored in a computer-readable recording medium that non-transitorily records data. As the recording medium, for example, a magnetic tape for data recording or a magnetic disk such as a hard disk can be used. As the recording medium, an optical disk such as a compact disc read only memory (CD-ROM) can also be used. A non-volatile semiconductor storage device may be used as a recording medium.

An interaction using a virtual space is performed in various fields. The user of the virtual space interacts with other users via an avatar. The virtual space in which the user participates by operating the avatar present in the virtual space is also referred to as a metaverse space. In the virtual space, the action of the avatar by the user's operation depends on, for example, both the setting of the virtual space and the object arranged in the space. In addition, the presence of excellent objects promotes longer use and stay in the virtual space. On the other hand, the management of the virtual space and the arrangement of the object in the virtual space may be performed by another person. In such a case, for example, the revenue paid from the entity operating the virtual space to the entity arranging the object is calculated.

The related art described in the background art causes a problem, such as it is difficult to allocate revenue related to an object appropriately. The revenue related to the object is generated by an avatar action to the object. An example advantage according to the present disclosure is that revenue related to an object can be allocated appropriately according to an avatar action.

Some or all of the above embodiments may be described as the following supplementary notes, but are not limited to the following.

### [Supplementary Note 1]

A billing system comprising:
at least one memory storing instructions; and
at least one processor configured to access the at least one memory and execute the instructions to:
detect an action of an avatar on an object in a virtual space;
estimate a degree of contribution of an object to revenue generated by an action of an avatar in a virtual space based on a detection result of the action of the avatar;
determine an allocation of revenue generated in the virtual space to a related entity based on the estimated degree of contribution of the object; and
output the determined allocation.

### [Supplementary Note 2]

The billing system according to Supplementary Note 1, wherein
the at least one processor is further configured to execute the instructions to:
determine an allocation of a usage fee for the virtual space to an entity that arranges the object based on a degree of contribution of the object to a fact that the avatar stays in the virtual space.

### [Supplementary Note 3]

The billing system according to Supplementary Note 1, wherein
the object is an object displayed as an advertisement, and
the at least one processor is further configured to execute the instructions to:
determine an allocation of a cost related to the advertisement to an advertiser based on the degree of contribution of the object to the fact that the avatar stays in the virtual space.

### [Supplementary Note 4]

The billing system according to Supplementary Note 1, wherein
the at least one processor is further configured to execute the instructions to:
determine an allocation to be paid by the advertiser among the usage fee based on a degree of contribution of the object to the fact that the avatar stays in the virtual space, in a case where the object is an object displayed as an advertisement, and at least a part of a usage fee for the usage of the virtual space where the avatar of the user, is paid by an advertiser exhibiting the object.

### [Supplementary Note 5]

The billing system according to Supplementary Note 1, wherein
the object is an object for movement to another virtual space, and
the at least one processor is further configured to execute the instructions to:
determine the allocation of the generated revenue to a related entity when the avatar moves to the another virtual space via the object.

### [Supplementary Note 6]

The billing system according to Supplementary Note 1, wherein
the at least one processor is further configured to execute the instructions to:
estimate the degree of contribution of the object based on at least one of the number of times of actions of the avatar on the object and a time during which the avatar is acting on the object.

### [Supplementary Note 7]

The billing system according to Supplementary Note 1, wherein
the at least one processor is further configured to execute the instructions to:
estimate the degree of contribution of the object based on a ratio of a conversation related to the object in a conversation between the avatars.

### [Supplementary Note 8]

The billing system according to Supplementary Note 1, wherein
the at least one processor is further configured to execute the instructions to:
estimate the degree of contribution of the object based on at least one of an attribute of the avatar and an attribute of a user who operates the avatar.

### [Supplementary Note 9]

A billing method comprising:
detecting an action of an avatar on an object in a virtual space;
estimating a degree of contribution of an object to revenue generated by an action of an avatar in a virtual space based on a detection result of the action of the avatar;
determining an allocation of revenue generated in the virtual space to a related entity based on the estimated degree of contribution of the object; and
outputting the determined allocation.

### [Supplementary Note 10]

The billing method according to Supplementary Note 9, further comprising:
determining an allocation of a usage fee for the virtual space to an entity that arranges the object based on a degree of contribution of the object to a fact that the avatar stays in the virtual space.

### [Supplementary Note 11]

The billing method according to Supplementary Note 9, wherein
the object is an object displayed as an advertisement, and
the billing method further comprising:
determining an allocation of a cost related to the advertisement to an advertiser based on the degree of contribution of the object to the fact that the avatar stays in the virtual space.

### [Supplementary Note 12]

The billing method according to Supplementary Note 9, further comprising:
determining an allocation to be paid by the advertiser among the usage fee based on a degree of contribution of the object to the fact that the avatar stays in the virtual space, in a case where the object is an object displayed as an advertisement, and at least a part of a usage fee for the usage of the virtual space where the avatar of the user, is paid by an advertiser exhibiting the object.

### [Supplementary Note 13]

The billing method according to Supplementary Note 9, wherein
the object is an object for movement to another virtual space, and
the billing method further comprising:
determining the allocation of the generated revenue to a related entity when the avatar moves to the another virtual space via the object.

### [Supplementary Note 14]

The billing method according to Supplementary Note 9, further comprising:
estimating the degree of contribution of the object based on at least one of the number of times of actions of the avatar on the object and a time during which the avatar is acting on the object.

### [Supplementary Note 15]

The billing method according to Supplementary Note 9, further comprising:
estimating the degree of contribution of the object based on a ratio of a conversation related to the object in a conversation between the avatars.

### [Supplementary Note 16]

The billing method according to Supplementary Note 9, further comprising:
estimating the degree of contribution of the object based on at least one of an attribute of the avatar and an attribute of a user who operates the avatar.

### [Supplementary Note 17]

A non-transitory recording medium recording a billing program that causes a computer to execute:
detecting an action of an avatar on an object in a virtual space;
estimating a degree of contribution of an object to revenue generated by an action of an avatar in a virtual space based on a detection result of the action of the avatar;
determining an allocation of revenue generated in the virtual space to a related entity based on the estimated degree of contribution of the object; and
outputting the determined allocation.

### [Supplementary Note 18]

The non-transitory recording medium recording the billing program according to Supplementary Note 17, wherein
the billing program further causes the computer to execute:
determining an allocation of a usage fee for the virtual space to an entity that arranges the object based on a degree of contribution of the object to a fact that the avatar stays in the virtual space.

### [Supplementary Note 19]

The non-transitory recording medium recording the billing program according to Supplementary Note 17, wherein
the object is an object displayed as an advertisement, and
the billing program further causes the computer to execute:
determining an allocation of a cost related to the advertisement to an advertiser based on the degree of contribution of the object to the fact that the avatar stays in the virtual space.

### [Supplementary Note 20]

The non-transitory recording medium recording the billing program according to Supplementary 17, wherein
the billing program further causes the computer to execute:
determining an allocation to be paid by the advertiser among the usage fee based on a degree of contribution of the object to the fact that the avatar stays in the virtual space, in a case where the object is an object displayed as an advertisement, and at least a part of a usage fee for the usage of the virtual space where the avatar of the user, is paid by an advertiser exhibiting the object.

### [Supplementary Note 21]

The non-transitory recording medium recording the billing program according to Supplementary 17, wherein
the object is an object for movement to another virtual space, and
the billing program further causes the computer to execute:
determining the allocation of the generated revenue to a related entity when the avatar moves to the another virtual space via the object.

### [Supplementary Note 22]

The non-transitory recording medium recording the billing program according to Supplementary 17, wherein
the billing program further causes the computer to execute:
estimating the degree of contribution of the object based on at least one of the number of times of actions of the avatar on the object and a time during which the avatar is acting on the object.

### [Supplementary Note 23]

The non-transitory recording medium recording the billing program according to Supplementary 17, wherein
the billing program further causes the computer to execute:
estimating the degree of contribution of the object based on a ratio of a conversation related to the object in a conversation between the avatars.

### [Supplementary Note 24]

The non-transitory recording medium recording the billing program according to Supplementary 17, wherein
the billing program further causes the computer to execute:
estimating the degree of contribution of the object based on at least one of an attribute of the avatar and an attribute of a user who operates the avatar.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed invention even if the claims are amended during prosecution.

1. A billing system comprising:
at least one memory storing instructions; and
at least one processor configured to access the at least one memory and execute the instructions to:
detect an action of an avatar on an object in a virtual space;
estimate a degree of contribution of an object to revenue generated by an action of an avatar in a virtual space based on a detection result of the action of the avatar;
determine an allocation of revenue generated in the virtual space to a related entity based on the estimated degree of contribution of the object; and
output the determined allocation.

2. The billing system according to claim 1, wherein
the at least one processor is further configured to execute the instructions to:
determine an allocation of a usage fee for the virtual space to an entity that arranges the object based on a degree of contribution of the object to a fact that the avatar stays in the virtual space.

3. The billing system according to claim 1, wherein
the object is an object displayed as an advertisement, and
the at least one processor is further configured to execute the instructions to:
determine an allocation of a cost related to the advertisement to an advertiser based on the degree of contribution of the object to the fact that the avatar stays in the virtual space.

4. The billing system according to claim 1, wherein
the at least one processor is further configured to execute the instructions to:
determine an allocation to be paid by the advertiser among the usage fee based on a degree of contribution of the object to the fact that the avatar stays in the virtual space, in a case where the object is an object displayed as an advertisement, and at least a part of a usage fee for the usage of the virtual space where the avatar of the user, is paid by an advertiser exhibiting the object.

5. The billing system according to claim 1, wherein
the object is an object for movement to another virtual space, and
the at least one processor is further configured to execute the instructions to:
determine the allocation of the generated revenue to a related entity when the avatar moves to the another virtual space via the object.

6. The billing system according to claim 1, wherein
the at least one processor is further configured to execute the instructions to:
estimate the degree of contribution of the object based on at least one of the number of times of actions of the avatar on the object and a time during which the avatar is acting on the object.

7. The billing system according to claim 1, wherein
the at least one processor is further configured to execute the instructions to:
estimate the degree of contribution of the object based on a ratio of a conversation related to the object in a conversation between the avatars.

8. The billing system according to claim 1, wherein
the at least one processor is further configured to execute the instructions to:
estimate the degree of contribution of the object based on at least one of an attribute of the avatar and an attribute of a user who operates the avatar.

9. A billing method comprising:
detecting an action of an avatar on an object in a virtual space;
estimating a degree of contribution of an object to revenue generated by an action of an avatar in a virtual space based on a detection result of the action of the avatar;
determining an allocation of revenue generated in the virtual space to a related entity based on the estimated degree of contribution of the object; and
outputting the determined allocation.

10. The billing method according to claim 9, further comprising:
determining an allocation of a usage fee for the virtual space to an entity that arranges the object based on a degree of contribution of the object to a fact that the avatar stays in the virtual space.

11. The billing method according to claim 9, wherein
the object is an object displayed as an advertisement, and
the billing method further comprising:
determining an allocation of a cost related to the advertisement to an advertiser based on the degree of contribution of the object to the fact that the avatar stays in the virtual space.

12. The billing method according to claim 9, further comprising:
determining an allocation to be paid by the advertiser among the usage fee based on a degree of contribution of the object to the fact that the avatar stays in the virtual space, in a case where the object is an object displayed as an advertisement, and at least a part of a usage fee for the usage of the virtual space where the avatar of the user, is paid by an advertiser exhibiting the object.

13. The billing method according to claim 9, wherein
the object is an object for movement to another virtual space, and
the billing method further comprising:
determining the allocation of the generated revenue to a related entity when the avatar moves to the another virtual space via the object.

14. The billing method according to claim 9, further comprising:
estimating the degree of contribution of the object based on at least one of the number of times of actions of the avatar on the object and a time during which the avatar is acting on the object.

15. The billing method according to claim 9, further comprising:
estimating the degree of contribution of the object based on a ratio of a conversation related to the object in a conversation between the avatars.

16. The billing method according to claim 9, further comprising:
estimating the degree of contribution of the object based on at least one of an attribute of the avatar and an attribute of a user who operates the avatar.

17. A non-transitory recording medium recording a billing program that causes a computer to execute:
detecting an action of an avatar on an object in a virtual space;
estimating a degree of contribution of an object to revenue generated by an action of an avatar in a virtual space based on a detection result of the action of the avatar;
determining an allocation of revenue generated in the virtual space to a related entity based on the estimated degree of contribution of the object; and
outputting the determined allocation.

18. The non-transitory recording medium recording the billing program according to claim 17, wherein
the billing program further causes the computer to execute:
determining an allocation of a usage fee for the virtual space to an entity that arranges the object based on a degree of contribution of the object to a fact that the avatar stays in the virtual space.

19. The non-transitory recording medium recording the billing program according to claim 17, wherein
the object is an object displayed as an advertisement, and
the billing program further causes the computer to execute:
determining an allocation of a cost related to the advertisement to an advertiser based on the degree of contribution of the object to the fact that the avatar stays in the virtual space.

20. The non-transitory recording medium recording the billing program according to claim 17, wherein
determining an allocation to be paid by the advertiser among the usage fee based on a degree of contribution of the object to the fact that the avatar stays in the virtual space, in a case where the object is an object displayed as an advertisement, and at least a part of a usage fee for the usage of the virtual space where the avatar of the user, is paid by an advertiser exhibiting the object.
